(19) United States
(12) Patent Application Publication
(10) Pub. No.: US 2020/0162960 A1
(43) Pub. Date: May 21, 2020

(54) METHODS CIRCUITS DEVICES SYSTEMS AND ASSOCIATED COMPUTER EXECUTABLE CODE FOR IMPLEMENTING CELL CONGESTION DETECTION IN A MOBILE NETWORK

(71) Applicant: SAGUNA NETWORKS LTD., Yokneam Illit (IL)

(72) Inventors: Daniel Nathan Frydman, Haifa (IL); Lior Fite, Zurit (IL)

(21) Appl. No.: 16/517,615

(22) Filed: Jul. 21, 2019

Related U.S. Application Data
(63) Continuation of application No. 14/637,427, filed on Mar. 4, 2015, now abandoned.
(60) Provisional application No. 61/975,824, filed on Apr. 6, 2014.

(51) Int. Cl. H04W 28/02; H04L 12/801

(52) U.S. Cl. CPC H04W 28/0284; H04W 28/08; H04L 47/11; H04W 28/02

(57) ABSTRACT

Disclosed are methods, circuits, devices, systems and associated computer executable code for operating a cellular network. According to some embodiments, a network core may be communicatively connected to one or more network access segments through a data tunnel, which data tunnel is monitored by a data traffic analyzer. The analyzer may monitor data flow through the data tunnel to estimate a data transfer load on one or more wireless coverage cells of a base-station of said network access segment. Estimating may include identifying and monitoring one or more packet streams encapsulated within the data flow. The traffic analyzer may perform packet inspection on data packets of one or more packet streams within the data tunnel and to identify a payload data-type within downstream packets heading towards a wireless client device. The analyzer may associate data packets of one or more packet streams within the data tunnel with a specific coverage cell of a specific base-station.

### RELATED APPLICATIONS

The present application is a continuation of U.S. patent application Ser. No. 14/637,427, filed on Mar. 4, 2015, which in turn claims priority from U.S. Provisional Patent Application No. 61/975,824, filed on Apr. 6, 2014, by the inventors of the present application. U.S. patent application Ser. No. 13/324,160, filed on Dec. 13, 2011 and registered as U.S. Pat. No. 8,812,609, and U.S. patent application Ser. No. 13/269,776, filed on Oct. 10, 2011 and registered as U.S. Pat. No. 8,943,216, and U.S. patent application Ser. No. 12/561,324, filed on Sep. 17, 2009 and registered as U.S. Pat. No. 8,369,328, are each hereby incorporated by reference in their entirety.

### FIELD OF THE INVENTION

The present invention relates generally to the field of cellular communication and networks, More specifically, the present invention relates to cell base-station congestion level detection, monitoring and analyzing.

### BACKGROUND

Since 2009, when for the first time the volume of data traffic over mobile networks exceeded that of voice traffic, mobile data has more or less tripled each year in volume, taking over more and more of the mobile traffic volume. The majority of this mobile data is video and the prediction is that as mobile data grows, the portion of mobile video will grow in a much faster rate than non-video mobile data. On the profitability side, video generates the lowest income to the operators per byte compared to other types of mobile data, which creates a big problem. In addition, video is an application which has inflexible requirements on the way traffic should be served over the network. In order to enable adequate user experience, the video must be supplied to the User Equipment (UE) according to strict bit-rate requirements. Any deviation from these requirements automatically leads to lousy experience and to the abandonment of this service by consumers. In order to enable coping with this problem, it is essential to continually be aware of the congestion level of the cells to which the video contents are being sent. Such information may enable handling the different types of traffic going to each cell in a manner that will enable video to be served in an optimal way, leading to enhanced user experience. On the other hand, such a solution shouldn't in any way degrade the behavior of the network. This leads to the need for a solution which will enable continuous updated information regarding the cell load of each cell that supports this solution while not degrading the network behavior.

### SUMMARY OF THE INVENTION

The present invention includes methods, circuits, devices, systems and associated computer executable code for implementing cell congestion detection in a mobile network. According to some embodiments of the present invention, there may be provided a system adapted to receive cellular traffic from a base-station, analyze the traffic, and return the analyzed information to the base-station. According to some other embodiments of the present invention, the system may be adapted to receive data associated with the cellular traffic from the base-station, analyze the traffic and the associated data, and return the analyzed information to the base-station. According to some embodiments of the present invention, the analysis may include determining the load of a cell or multiple cells of the base-station, or the load of the entire base-station.

The present invention also include methods, circuits, devices, systems and associated computer executable code for operating a cellular network. According to some embodiments, a network core may be communicatively connected to one or more network access segments through a data tunnel, which data tunnel is monitored by a data traffic analyzer. The analyzer may monitor data flow through the data tunnel to estimate a data transfer load on one or more wireless coverage cells of a base-station of said network access segment. Estimating may include identifying and monitoring one or more packet streams encapsulated within the data flow. The traffic analyzer may perform packet inspection on data packets of one or more packet streams within the data tunnel and to identify a payload data-type within downstream packets heading towards a wireless client device. The analyzer may associate data packets of one or more packet streams within the data tunnel with a specific coverage cell of a specific base-station.

According to further embodiments, the traffic analyzer may be adapted to update a data set indicating data transfer loads for each of one or more wireless coverage cells of one or more base-stations of said network access segment. A data delivery scheduler may be adapted to alter delivery prioritization of data packets carrying data of one or more non-realtime data-types to a given coverage cell at least partially based on an estimated data transfer load of the given coverage cell. Additionally, the base-station may be adapted to provide an indication of a wireless data transfer condition associated with one or more coverage cells of said base-station.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows an example of a mobile network basic structure which includes the system of the present invention inline to the traffic;

FIG. 2 shows another example of a mobile network basic structure which includes the system of the present invention aside or in parallel to the traffic;

FIG. 3 shows an example of a table maintained by the system of the present invention, recording the maximum throughput per number of concurrent users; and

FIG. 4 shows an example of the parameters of each active session table, maintained by the system of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including magnetic hard disks, solid state disks (SSD), floppy disks, optical disks, CD-ROMs, DVDs, BlueRay disks, magnetic-optical disks, read-only memories (ROMs), random access memories (RAMs) electrically programmable read-only memories (EPROMs), electrically erasable and programmable read only memories (EEPROMs), Flash memories, magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method, The desired structure for a variety of these systems will appear from the description below. In addition, embodiments of the present invention are not described with reference to any particular programming language. It will be appreciated that a variety of programming languages may be used to implement the teachings of the inventions as described herein.

The terms mobile network and cellular network are being used interchangeably throughout the present application.

Originally, mobile networks were built to carry voice calls, in which case all calls were equal and therefore received equal priority when being transmitted by a base-station's cell. With the addition of new types of traffic passing through the cellular networks such as video streaming, which consume a lot of bandwidth compared to voice calls, and which have strict Quality-of-Service (QoS) demands such as latency and bandwidth, there is a need to inspect the traffic in order to optimize traffic over the mobile network. In addition, there is a need to continuously determine the cell and/or base-station congestion for network traffic optimization.

According to some embodiments of the present invention, there may be provided a system adapted to receive cellular traffic going to a base-station, analyze the traffic, and return the analyzed information to the base-station. According to some other embodiments of the present invention, the system may be adapted to receive data associated with the cellular traffic from the base-station, analyze the traffic and the associated data, and return the analyzed information to the base-station. According to some embodiments of the present invention, the analysis may include detecting the load of a cell or multiple cells of the base-station, or the load of the entire base-station.

According to some embodiments of the present invention, the system may be placed in the network access. According to some embodiments of the present invention, the system may be a dedicated hardware located substantially near the base-station. According to some other embodiments of the present invention, the system may be a computer running a special purpose application and located substantially near the base-station. According to even some other embodiments of the present invention, the system may be a software agent residing on the base-station's memory and executed by the base-station's processing unit, on a virtual machine or in any other manner.

According to some embodiments of the present invention, the traffic flowing from the mobile network core and into the base-station may flow through the system, i.e. the traffic may flow from the mobile network core into the system and from the system into the base-station. According to some other embodiments of the present invention, a copy of the traffic flowing from the mobile network core and into the base-station or at least part of the traffic may flow into the system.

According to some embodiments of the present invention, the system may receive cellular traffic of a single cell or of multiple cells of the base-station, inspect and parse the traffic to determine various characteristics of the traffic such as its type (e.g. streaming video, downloaded video, voice call, Text message, picture, mail, etc.), packet size, properties related to the type (e.g. video resolution), protocol, session I.D., source address, destination address, etc. According to some embodiments of the present invention, the system may also receive from the base-station any information collected, extracted or detected by the base-station, such as for example: information associated with the data relating to some of the packets, or each packet. This information may include for example, radio link condition, and packet delay within the cell. The system may also receive from the base-station information regarding the number of users and/or the number of concurrent users for a single cell or for some or all of the cells. The system may also receive from the base-station information regarding the throughputs of a single cell or for some or all of the cells. According to some embodiments of the present invention, the system may receive certain information from other network entities, these entities may include other (e.g. nearby) base-stations, similar systems of other (e.g. nearby) base-stations, Base-station Controller (BSC) or the Mobile Switching Center (MSC). According to some embodiments of the present invention, the system may use the cellular traffic parsed information and/or the information received from the base-station and/or information received from other entities in order to determine cell load and/or cell congestion.

According to some embodiments of the present invention, the system may hold and maintain internal lists and/or tables with different parameters relevant to the congestion information such as: minimum and maximum number of concurrent users, minimum total throughput going via this cell per number of users, maximum throughput going via this cell per number of users, throughput per application etc., with different combinations and matrixes including these information columns. The aggregation of the information may be implemented by continually monitoring the number of concurrent active/non-active users on a cell and monitoring the total throughput reaching that specific cell. The system may analyze and report total cell congestion levels and cell congestion levels per number of concurrent users.

According to some embodiments of the present invention, the total cell congestion levels and cell congestion levels per number of concurrent users may be continually managed, analyzed and/or reported to additional entities for better network management or any other purpose.

According to some embodiments, these entities may be for example the Base-station Controller (BSC), the Mobile Switching Center (MSC), the base-station itself or any other relevant entity according to the specific network.

According to some embodiments of the present invention, the system may interface with the base-station's scheduler. The scheduler may use congestion information as well as other information it may receive from the system for prioritizing traffic according to different parameters such as type of traffic, and different types of service levels. For example, streaming video will have high priority, while SW updates, pdf files etc. will have low priority.

According to some embodiments of the present invention, the system of the present invention may report to the base-station and/or to other network entities, the current load on a cell per the current number of concurrent users, along with the maximum throughput per that number of concurrent users so that the network and/or the base-station may optimize the traffic. For example, the system may report that the current number of users in a cell is 60 and the current cell's throughput is 80 Mb/s. The system may also report that the maximum load on that cell per 60 concurrent users was 100 Mb/s. Since the current load on the cell reached 80% of the maximum load, the network may take measures for optimizing the traffic such as slowing down non real-time traffic, or by the base-station's scheduler deferring less sensitive data. Similar bandwidth control capabilities may exist in the system itself, which may be able to throttle “non real time” data streams, thus freeing network bandwidth for video and other real time traffic by means such as Transmission Control Protocol (TCP) manipulation and controlling the rate of the data being sent on these streams towards the User Equipment (UE).

According to some embodiments, the system of the present invention may generate reports and/or statistical reports of the network condition, and send these reports to the network managers so that they may use it for improving the network. For example, by adding a base-station.

According to some embodiments of the present invention, the system may collect the data in a form of tables, database, linked lists or in any other form or combination of forms.

### DETAILED DESCRIPTION OF THE DRAWINGS

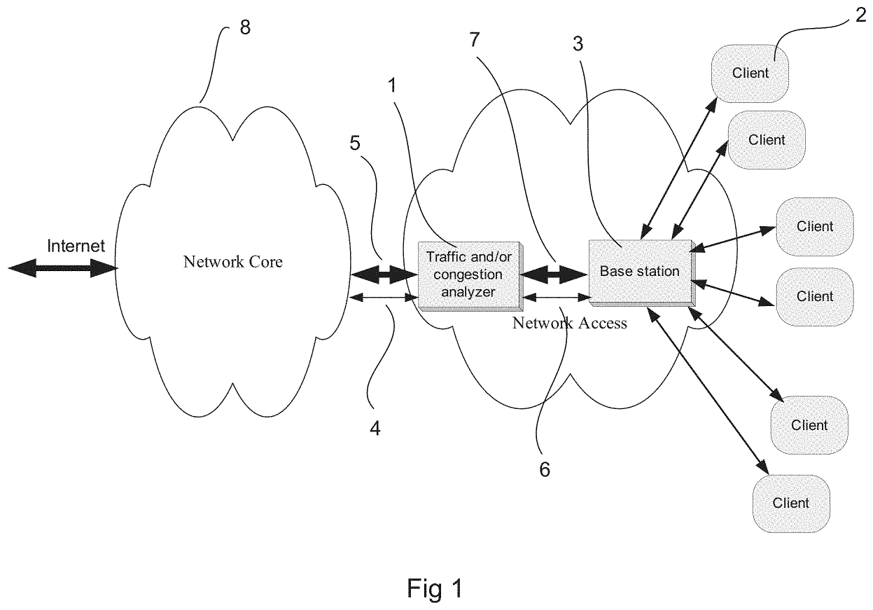

FIG. 1 is a diagram exemplifying the basic structure of a mobile network which includes the system of the present invention. The traffic flowing between the core of the network (8) and the client (2) passes through the system (1) of the present invention. The traffic flows from the core of the network (8) through line (5) into the system (1), and from the system it flows through line (7) to the base-station (3). The base-station (3) then transmits the traffic over the air to the client(s) (2). In the opposite direction the traffic originated in the client (2) is transmitted over the air to the base-station (3), the base-station may pass it to the system (1) through line (7) which may pass it on to the network core (8) through line (5). Alternatively (not illustrated), the traffic received by the base-station (3) from the client (2) may bypass the system (1) and sent directly to the network core (8). According to this example, the system (1) analyzes the traffic flowing through it, and may receive other information from the base-station (3) through control line (6) and/or from other network entities through control line (4). Based on all the data gathered by it, the system (1) then determines cell and/or base-station congestion, and sends this information to the base-station on control line (6), and/or to other network entities on control line (4).

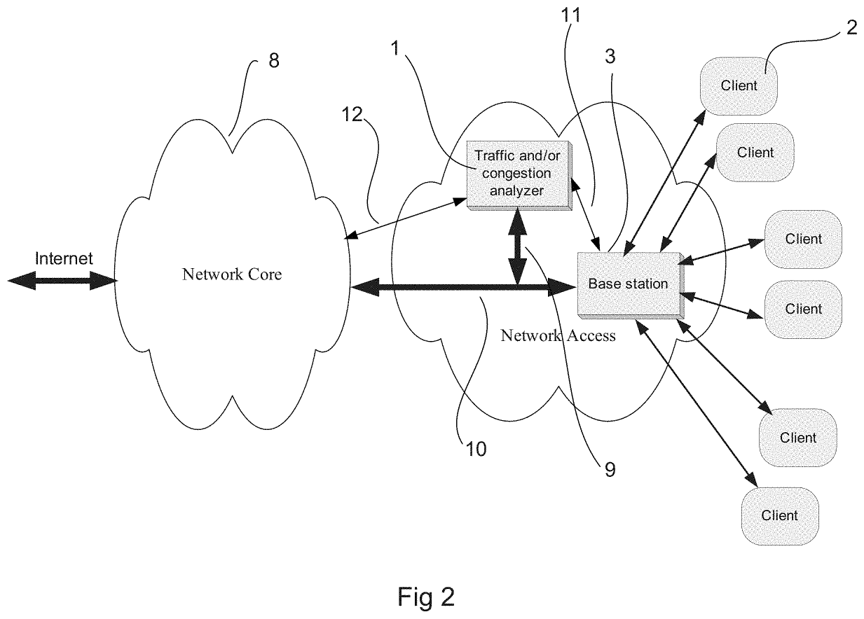

FIG. 2 is a diagram exemplifying another basic structure of a mobile network which includes the system of the present invention. The traffic flowing between the core of the network (8) and the client (2) passes through the base-station (3) over data channel 10, The base-station (3) then transmits the traffic over the air to the client(s) (2). in the opposite direction the traffic originated in the client (2) is transmitted over the air to the base-station (3), the base-station sends the traffic to the network core (8) over data channel (10). The system (1) of the present invention listens, using a channel (9) connected physically or logically or in some other way, to the traffic flowing on the data channel (10) between the network core and the base-station. According to this example, the system (1) analyzes the traffic it receives, and may receive other information from the base-station (3) through control line (11) and/or from other network entities through control line (12). Based on all the data gathered by it, the system (1) then determines cell and/or base-station congestion, and sends this information to the base-station on control line (11), and/or to other network entities on control line (12). The system of the present invention (1) may also interface with the base-station's scheduler over control line (11) in order to enhance the scheduling decisions in the base-station.

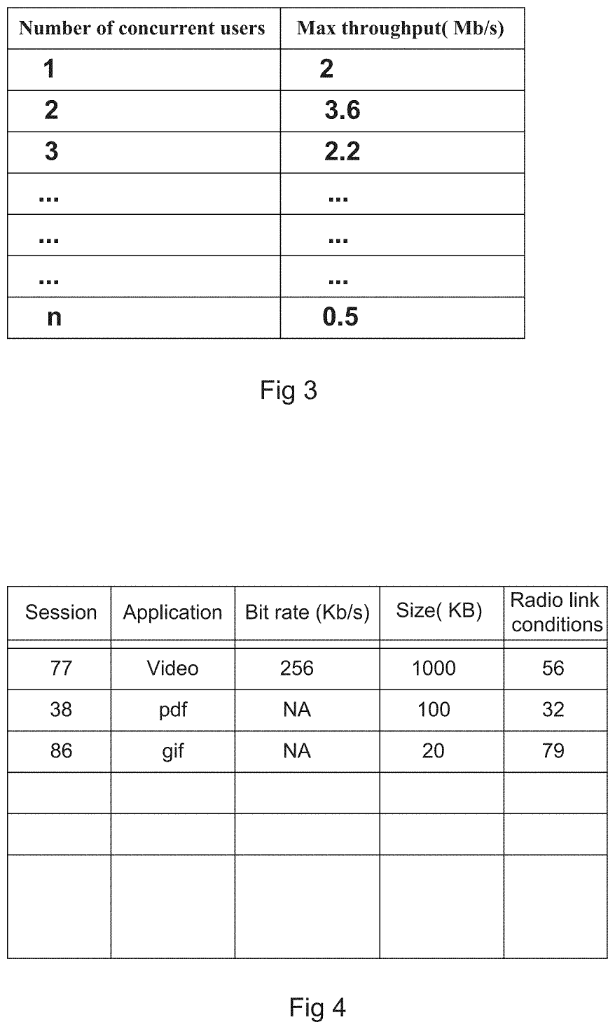

FIG. 3 shows an example of a table maintained by the system of the present invention. In this table the maximum throughput per number of concurrent users is constantly updated. If for instance the current number of concurrent users is 50, and the throughput is 7 Mb/s, but the maximum throughput for 50 users in the table is 6 Mb/s, then the table will be updated to 7 Mb/s in order to save the maximum throughput achieved for 50 users. This table updating will be done every time the actual throughput for a certain number of concurrent users is higher than the maximum throughput saved in the table. The system of the present invention may keep such a table for each cell and/or for the entire base-station.

FIG. 4 shows an example of another table maintained by the system of the present invention. In this table the parameters of each active session are recorded. In this example the type of application (e.g. streaming video, email, text message, browsing, etc.), bit rate, file size, and radio link quality are recorded in the table for each active session. Other parameters may be recorded as well, such as number of retransmissions, number of lost packets, delay, etc. The information gathered in the table is then communicated to the base-station's scheduler and/or to other network entities such as the Base-station Controller (BSC) or the Mobile Switching Center (MSC).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A cellular network comprising:
a network core;
a data tunnel connecting said network core to one or more base stations;
a computing device configured to:
i. monitor data flow through said data tunnel;
ii. inspect and parse the data flow to identify packet streams encapsulated within the data flow and determine characteristics of the packet streams; and
iii. estimate a congestion level of cells of the base stations based on data extracted by said computing device by inspecting packets within the data flow;, and
a data delivery scheduler comprising a processor communicatively coupled to said computing device and the base stations and configured to alter delivery prioritization of data packets carrying data of one or more non-realtime data-types to a given coverage cell of the base stations.

2. The network according to claim 1, wherein said computing device is configured to perform packet inspection of data packets of one or more packet streams within the data tunnel and to identify a payload data-type within downstream packets heading towards a wireless client device.

3. The network according to claim 1, wherein said computing device is configured to associate data packets of one or more packet streams within the data tunnel with a specific coverage cell of a specific base-station.

4. The network according to claim 3, wherein said computing device is configured to update a data set indicating data transfer loads for each of one or more wireless coverage cells of the one or ore base-stations.

5. The network according to claim 1, wherein said computing device is further configured to receive within the data flow, from the base station, a signal indicating a wireless data transfer condition associated with one or more coverage cells of the base-stations.

6. A method of operating a cellular network comprising:
transferring encapsulated packet streams between a network core and one or more base stations, through a data tunnel;
monitoring data flow through the data tunnel;
inspecting and parsing the data flow to identify the packet streams encapsulated within the data flow and determine characteristics of the packet streams;
estimate a congestion level of cells of the base stations based on data extracted by said computing device by inspecting packets within the data flow; and
altering delivery prioritization of data packets carrying data of one or more non-realtime data-types to a given coverage cell of the base stations at least partially based on an estimated data transfer load of the given coverage cell.

7. The method according to claim 6, further comprising performing packet inspection of data packets of one or more packet streams within the data tunnel to identify a payload data-type within downstream packets heading towards a wireless client device.

8. The method according to claim 6, further comprising associating data packets of one or more packet streams within the data tunnel with a specific coverage cell of a specific base-station.

9. The method according to claim 8, further comprising generating a data set indicating data transfer loads for each of one or ore wireless coverage cells of the one or more base-stations.

10. The method according to claim 6, further comprising receiving within the data flow, an indication from the base stations of a wireless data transfer condition associated with one or more coverage cells of the base-stations.
